(19) United States
(12) Patent Application Publication
(10) Pub. No.: US 2012/0194883 A1
(43) Pub. Date: Aug. 2, 2012

(54) CHARACTER DETECTION APPARATUS, CHARACTER DETECTION METHOD, AND COMPUTER-READABLE STORAGE MEDIUM

(75) Inventor: Tomoo Yamanaka, Toyokawa-shi (JP)

(73) Assignee: Konica Minolta Business Technologies, Inc., Tokyo (JP)

(21) Appl. No.: 13/393,776

(22) PCT Filed: Jan. 4, 2012
(86) PCT No.: PCT/JP12/00014

§ 371 Date: Mar. 1, 2012

(30) Foreign Application Priority Data
Dec. 29, 2010 (JP) 2010-294503

(51) Int. Cl. H04N 1/46

(52) U.S. Cl. 358/532; 358/530

(57) ABSTRACT

A character detection apparatus is provided which detects, from an image including a first image representing a character and a second image representing a translucent object, the character. The character detection apparatus includes a hue distribution calculating portion that, for each of blocks obtained by dividing an overlapping region in which the first image is overlapped by the second image, calculates a frequency of appearance of pixels for each of hues, and a detection portion that detects the character from the overlapping region based on the frequency for each of the hues.

This application is based on Japanese patent application No. 2010-294503 filed on Dec. 29, 2010, the contents of which are hereby incorporated by reference.

### TECHNICAL FIELD

The present invention relates to an apparatus, a method, and the like for performing image processing on an image that includes a transparent image.

### BACKGROUND ART

Recent years have seen the widespread use of image forming apparatuses that include various functions such as copying, PC printing, scanning, faxing, and serving as a file server. Such image forming apparatuses are called a “multifunction device” or an “MFP” (Multi-Functional Peripheral).

PC printing is a function for receiving image data from a personal computer and printing an image on a sheet of paper.

Also, applications for performing rendering with a personal computer have been distributed in recent years. Such applications are called “rendering software”. Some rendering software includes a function for displaying a transparent image on a display.

A “transparent image” is characteristic in that an image of an object that is behind the transparent image can be seen through the transparent image.

Specifically, as shown in FIG. 4A for example, a transparent image 40a is overlaid on the left half of a background image 40b. As shown in FIG. 4B, the portion of the background image 40b that is overlapped by the transparent image 40a can be seen through the transparent image 40a. However, when a non-transparent image 40c, which is not a transparent image, is overlaid on the right half of the background image 40b, the background image 40b cannot be seen through the non-transparent image 40c. The higher the transparency of the transparent image is, the more visible the background image that is overlapped by the transparent image is.

A transparent image displayed by a personal computer can be printed on a sheet of paper by an image forming apparatus. Before the transparent image is printed, pixel decimation processing is performed in accordance with the level of transparency as shown in FIGS. 5B and 5C. The image behind the transparent image is then printed in the positions of the pixels that were removed in the pixel decimation processing. Accordingly, the background image can be seen through the transparent image.

Also, technology for detecting characters such as letters and numbers in an image has been put into practical use. Furthermore, methods for precisely detecting characters have also been proposed. For example, methods such as the following have been proposed.

A digital image is divided into multiple blocks, a contrast amount relating to the pixel values of the pixels included in a block is obtained for each block, a pixel value bimodality evaluation value relating to a histogram of the pixel values of the pixels included in a block is obtained for each block, a contrast threshold value is obtained based on the contrast amounts, a bimodality threshold value is obtained based on the pixel value bimodality evaluation values, and the blocks are classified as text blocks or non-text blocks. In this classifying, a block is classified into a text block if the contrast amount and the pixel value bimodality evaluation value thereof satisfy a first criterion that is based on the contrast threshold value and the bimodality threshold value, and a block is classified into a non-text block if the first criterion is not satisfied (Patent Literature 1).

### CITATION LIST

Patent Literature 1: Japanese Laid-open Patent Publication No. 2010-081604

### SUMMARY OF THE INVENTION

### Technical Problem

However, with conventional methods such as that disclosed in Patent Literature 1, characters that are overlapped by a transparent image cannot be favorably detected. This is because the entirety of the portion that is overlapped by the transparent image is determined to be a text region.

The present invention has been achieved in light of such an issue, and an object thereof is to enable characters overlapped by a transparent image to be detected more precisely than in conventional technology.

### Solution to Problem

According to an aspect of the present invention, a character detection apparatus that detects, from an image including a first image representing a character and a second image representing a translucent object, the character, the character detection apparatus includes a hue distribution calculating portion that, for each of blocks obtained by dividing an overlapping region in which the first image is overlapped by the second image, calculates a frequency of appearance of pixels for each of hues, and a detection portion that detects the character from the overlapping region based on the frequency for each of the hues.

Preferably, the character detection apparatus may include a density distribution calculating portion that calculates a density frequency in the overlapping region, the density frequency being a frequency of appearance of pixels for each of densities, a replacement portion that, in a case where a first density frequency having uniform sharpness and a second density frequency having uniform sharpness are calculated as the density frequency, replaces a pixel, in the overlapping region, having a density different from a density corresponding to the first density frequency and from a density corresponding to the second density frequency with a first pixel having a first hue of the hues, a generating portion that, in a case where a first frequency, a second frequency and a third frequency of the frequencies are peaks, the first frequency being a frequency for the first hue, the second frequency being a frequency for a second hue of the hues and the third frequency being a frequency for a third hue of the hues, and where a difference between the third frequencies of any two of the blocks is smaller than a difference between the first frequencies of said two of the blocks and a difference between the second frequencies of said two the blocks, generates a first replacement image by replacing a third pixel that has the third hue and is a part of the replaced pixels in the overlapping region with the first pixel, and generates a second replacement image by replacing the third pixel of the replaced pixels in the overlapping region with a second pixel having the second hue, a first closing processing portion that performs closing on the first pixel in the first replacement image, and a second closing processing portion that performs closing on the second pixel in the second replacement image. The detection portion may detect, as the character, a set of pixels that are located at positions corresponding to positions of the first pixel in the closing processed first replacement image or at positions corresponding to positions of the second pixel in the closing processed second replacement image, from the overlapping region.

Alternatively, the character detection apparatus may include a generating portion that, in a case where a first frequency and a second frequency of the frequencies are peaks, the first frequency being a frequency for a first hue of the hues, and the second frequency being a frequency for a second hue of the hues, generates a first replacement image by replacing a second pixel having the second hue of pixels in the overlapping region with a first pixel having the first hue, and generates a second replacement image by replacing the first pixel of the pixels in the overlapping region with the second pixel, a first closing processing portion that performs closing on the first pixel in the first replacement image, and a second closing processing portion that performs closing on the second pixel in the second replacement image. The detection portion may detect, as the character, a set of pixels that are located at positions corresponding to positions of the first pixel in the closing processed first replacement image or at positions corresponding to positions of the second pixel in the closing processed second replacement image, from the overlapping region.

These and other characteristics and objects of the present invention will become more apparent by the following descriptions of preferred embodiments with reference to drawings.

### BRIEF DESCRIPTION OF DRAWINGS

FIG. 1 is a diagram showing an example of a network system including an image forming apparatus.

FIG. 2 is a diagram showing an example of a hardware configuration of an image forming apparatus.

FIG. 3 is a diagram showing an example of a configuration of an image processing circuit.

FIGS. 4A and 4B show diagrams illustrating an example of how a transparent image and a non-transparent image are overlaid on a background image.

FIGS. 5A to 5C show diagrams illustrating examples of characteristics of transparent images.

FIG. 6 is a diagram illustrating an example of how a transparent image is overlaid on a background image.

FIGS. 7A and 7B show diagrams showing an example of a positional relationship between an original image, a transparent image, a background image, and so on.

FIGS. 8A and 8B show diagrams showing an example of a transparent image overlapping region and blocks.

FIG. 9 shows a histogram showing an example of the number (distribution) of pixels for each level of hue.

FIG. 10 is a diagram showing an example of a replaced image.

FIG. 11 is a diagram showing an example of blocks.

FIG. 12A to 12C show histograms showing an example of the number (distribution) of pixels for each level of hue.

FIG. 13 is a diagram showing an example of a configuration of a character pixel determining portion.

FIG. 14 shows diagrams illustrating an example of processing performed by a first pixel replacement portion, a first closing processing portion, and a first character pixel determining portion.

FIG. 15 shows diagrams illustrating an example of processing performed by a second pixel replacement portion, a second closing processing portion, and a second character pixel determining portion.

FIG. 16 is a diagram illustrating an example of processing performed by an OR operation portion.

FIG. 17 is a diagram showing an example of a configuration of an image processing circuit.

FIGS. 18A and 18B are diagrams showing an example of a positional relationship between an original image, a transparent image, a background image, and so on.

FIG. 19 is a diagram showing an example of a transparent image overlapping region.

FIG. 20 shows a histogram showing an example of the number (distribution) of pixels for each level of hue.

FIG. 21 is a diagram showing an example of a configuration of a character pixel presence estimating portion.

FIG. 22 is a diagram showing an example of blocks.

FIG. 23 shows histograms showing an example of the number (distribution) of pixels for each level of hue.

FIG. 24 shows an example of a binary image.

FIG. 25 shows diagrams illustrating an example of processing performed by a first closing processing portion and a first character pixel determining portion.

FIG. 26 shows diagrams illustrating an example of processing performed by a second closing processing portion and a second character pixel determining portion.

FIG. 27 is a diagram illustrating an example of processing performed by an OR operation portion.

### DESCRIPTION OF EMBODIMENTS

### First Embodiment

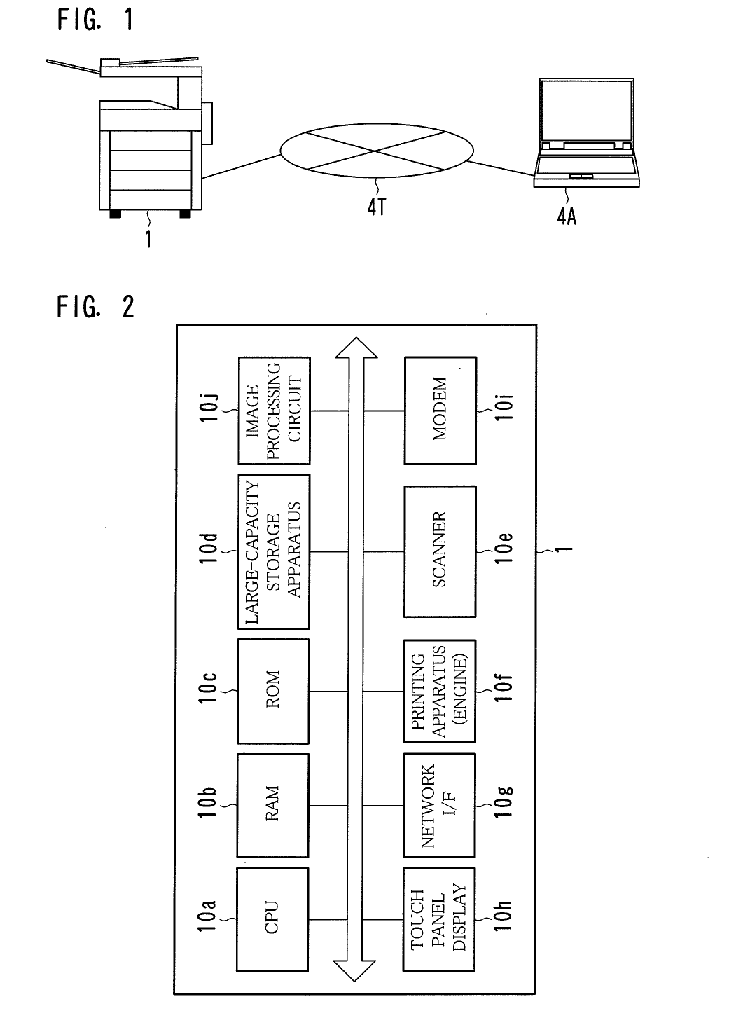

FIG. 1 is a diagram showing an example of a network system including an image forming apparatus 1. FIG. 2 is a diagram showing an example of a hardware configuration of the image forming apparatus 1.

The image forming apparatus 1 shown in FIG. 1 is an apparatus that is generally called a multifunction device or an MFP (Multi-Functional Peripheral) and includes functions such as copying, networking printing (PC printing), faxing, and scanning.

The image forming apparatus 1 can exchange image data with an apparatus such as a personal computer 4A via a communication line 4T such as a LAN (Local Area Network), a public line, or the Internet.

As shown in FIG. 2, the image forming apparatus 1 is configured by a CPU (Central Processing Unit) 10a, a RAM (Random Access Memory) 10b, a ROM (Read Only Memory) 10c, a large-capacity storage apparatus 10d, a scanner 10e, a printing apparatus 10f, a network interface 10g, a touch panel display 10h, a modem 10i, an image processing circuit 10j, and the like.

The scanner 10e is an apparatus that reads an image such as photographs, characters, pictures, charts, and the like that are recorded on an original sheet, and generates image data.

The touch panel display 10h displays, for example, a screen for presenting messages and instructions to a user, a screen for allowing a user to input processing commands and conditions, and a screen showing the results of processing performed by the CPU 10a. The touch panel display 10h also detects a position touched by the user's finger, and transmits a signal indicating the detection result to the CPU 10a.

The network interface 10g is an NIC (Network Interface Card) for communicating with other apparatuses such as the personal computer 4A via the communication line 4T.

The modem 10i is an apparatus for exchanging image data using a protocol such as G3 with other fax terminals via a fixed telephone network.

The image processing circuit 10j performs image processing on an image to be printed based on image data transmitted from the personal computer 4A. Respective portions of the image processing circuit 10j are implemented by circuits such as an ASIC (Application Specific Integrated Circuit) and an FPGA (Field Programmable Gate Array). Processing performed by each portion of the image processing circuit 10j will be described later.

The printing apparatus 10f prints an image that has been read by the scanner 10e, an image that has been subjected to image processing by the image processing circuit 10j or the like on a sheet of paper.

The ROM 10c and the large-capacity storage apparatus 10d store an OS (Operating System) and programs such as firmware and applications. The programs are loaded into the RAM 10b and executed by the CPU 10a as needed. The large-capacity storage apparatus 10d can be a hard disk drive, flash memory or the like.

Next, a configuration of the image processing circuit 10j and image processing performed by the image processing circuit 10j will be described.

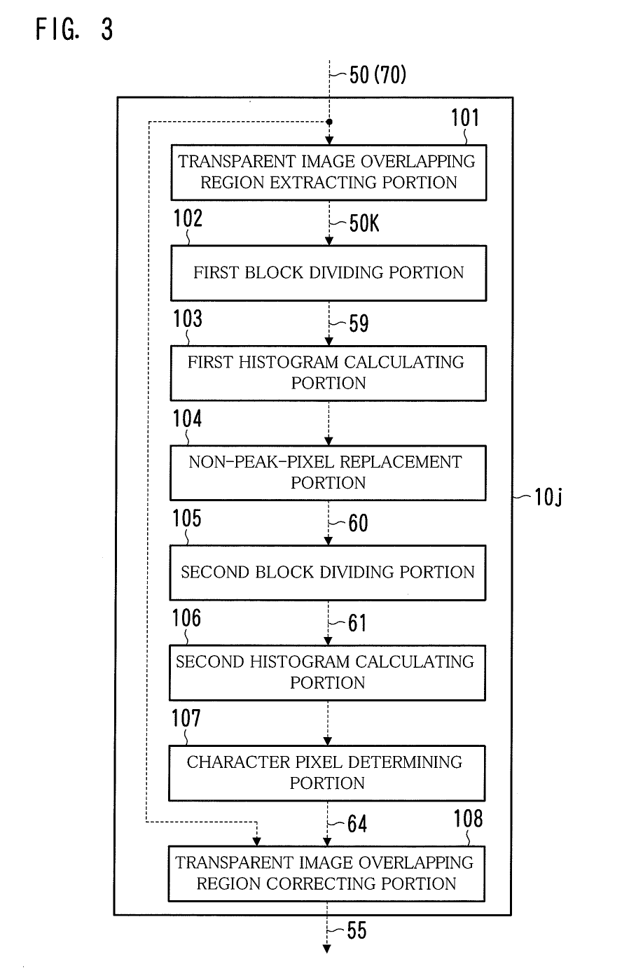

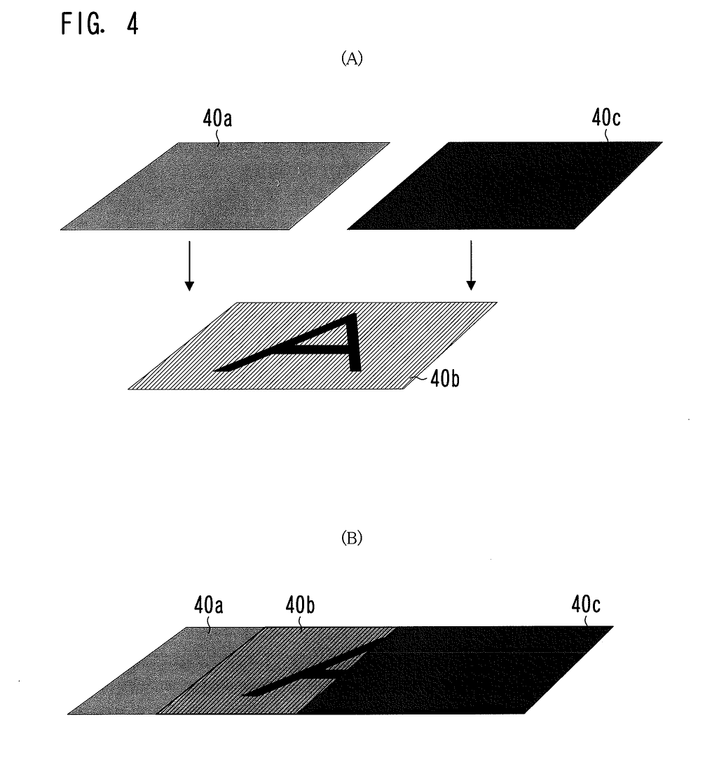

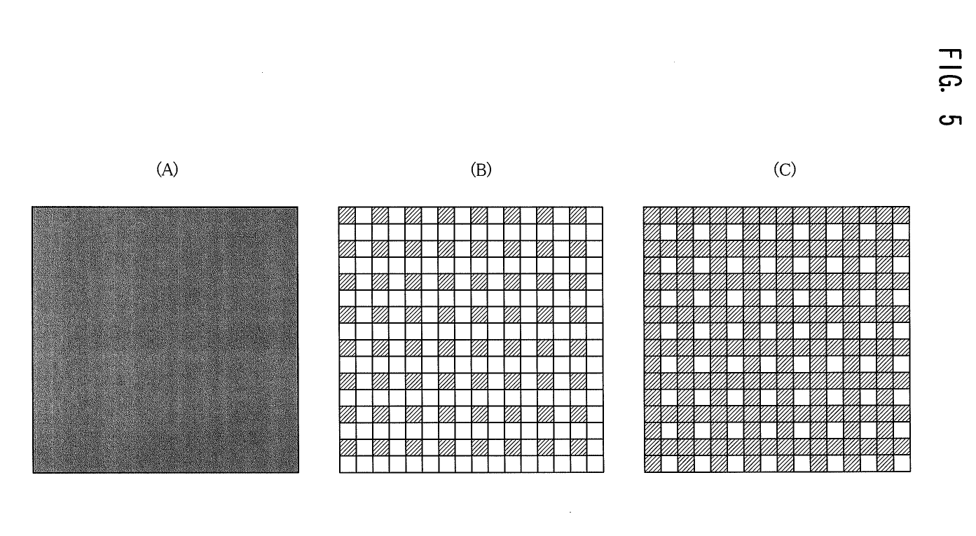

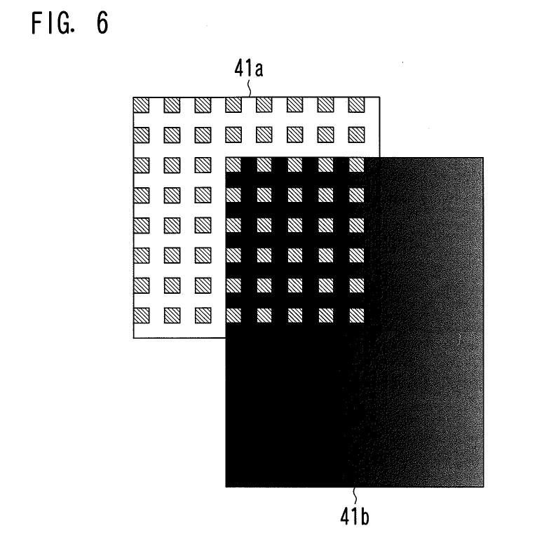

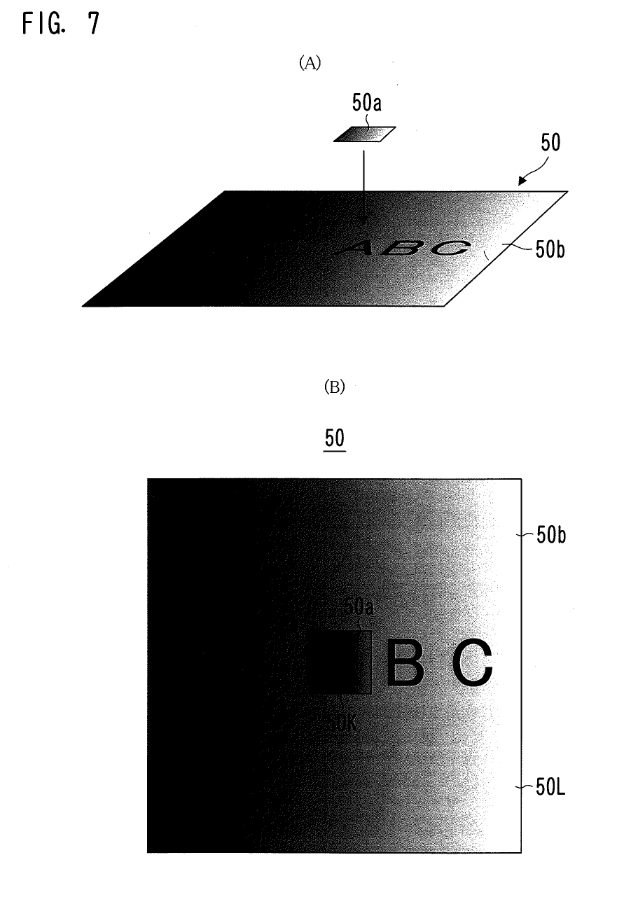

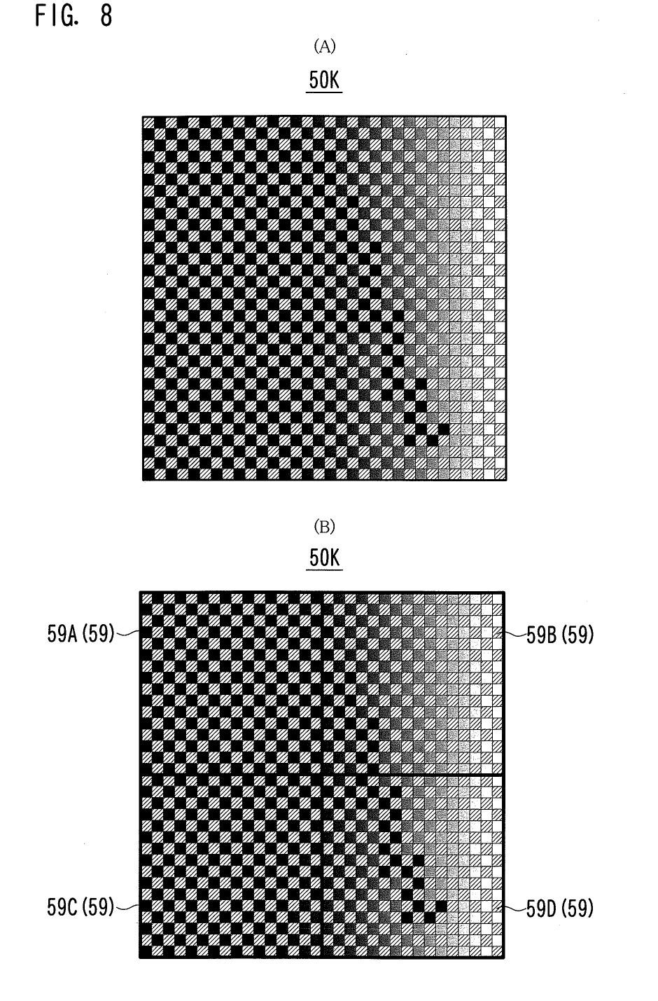

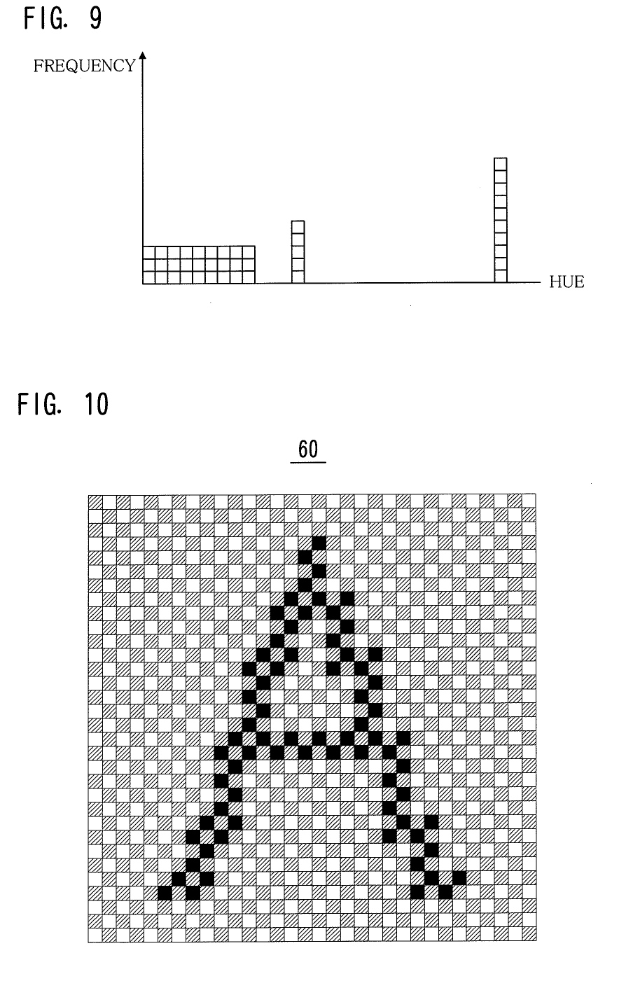

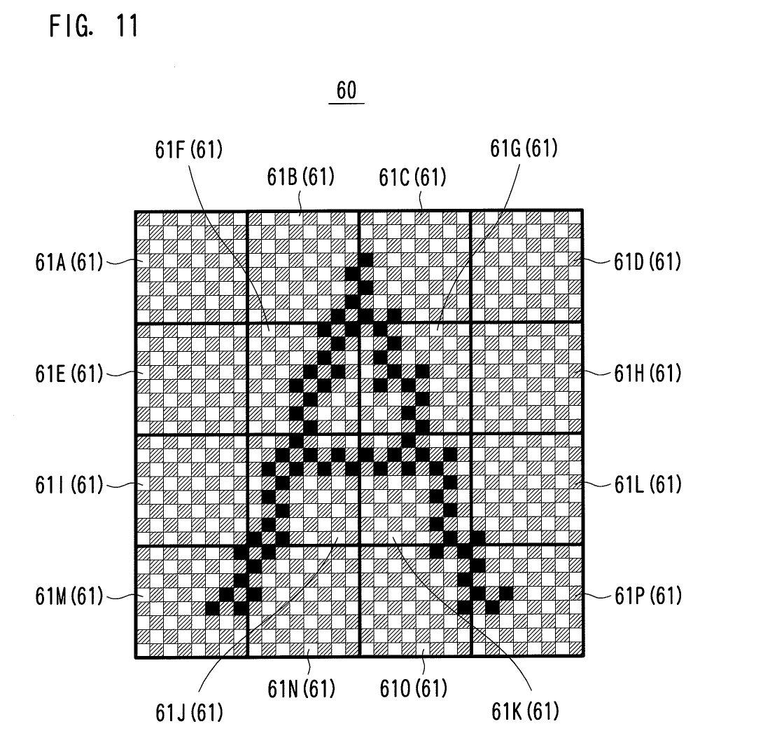

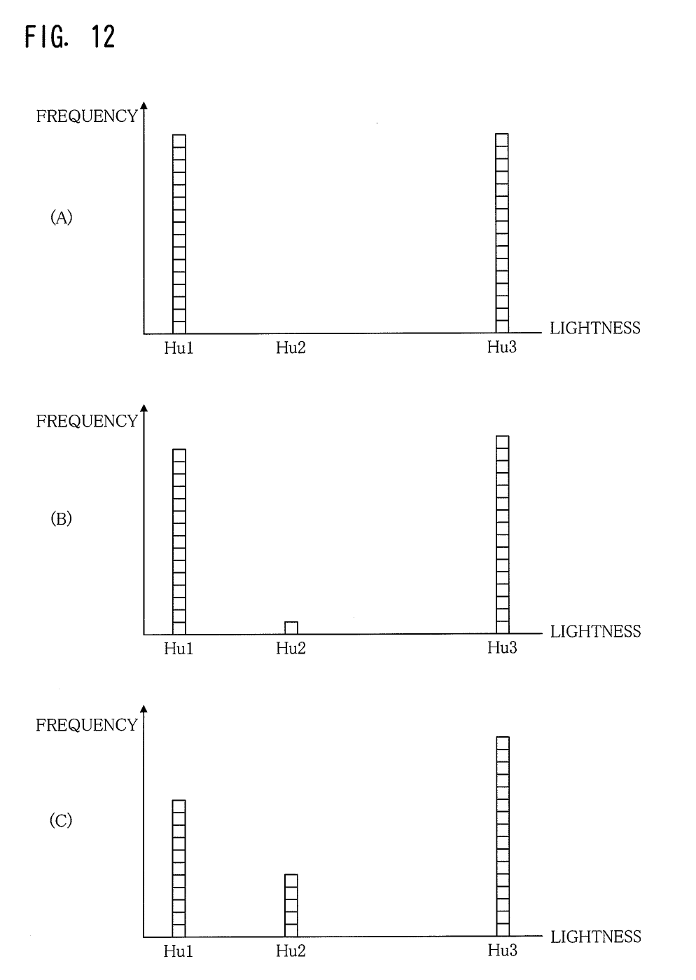

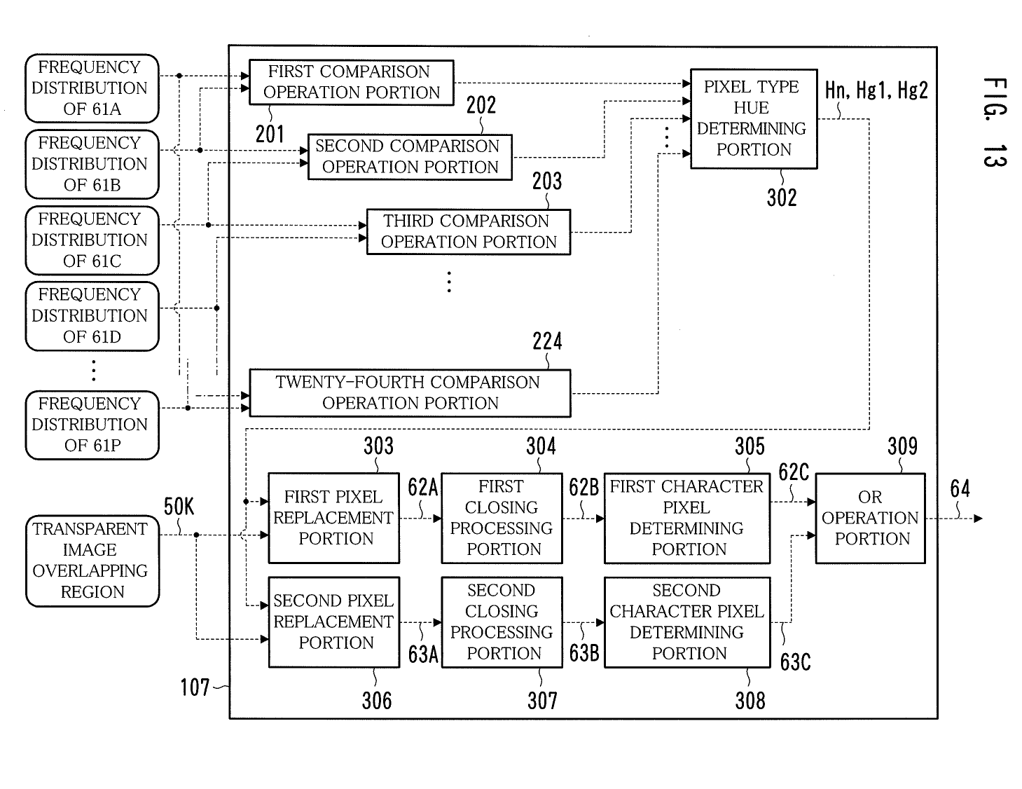

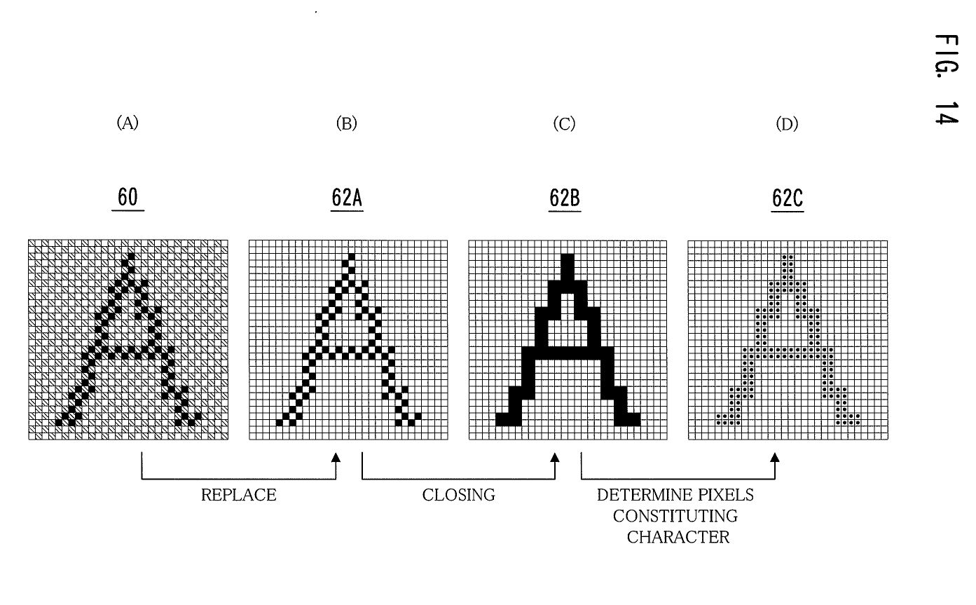

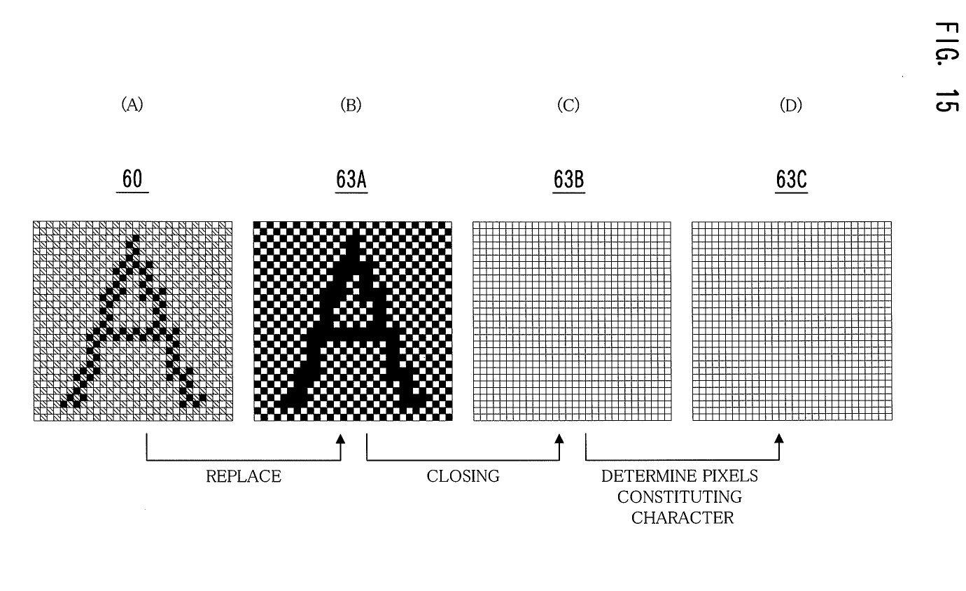

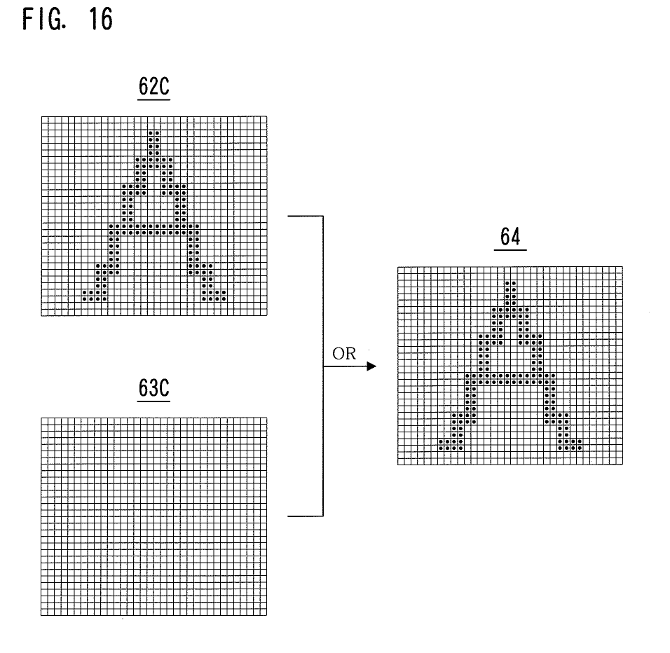

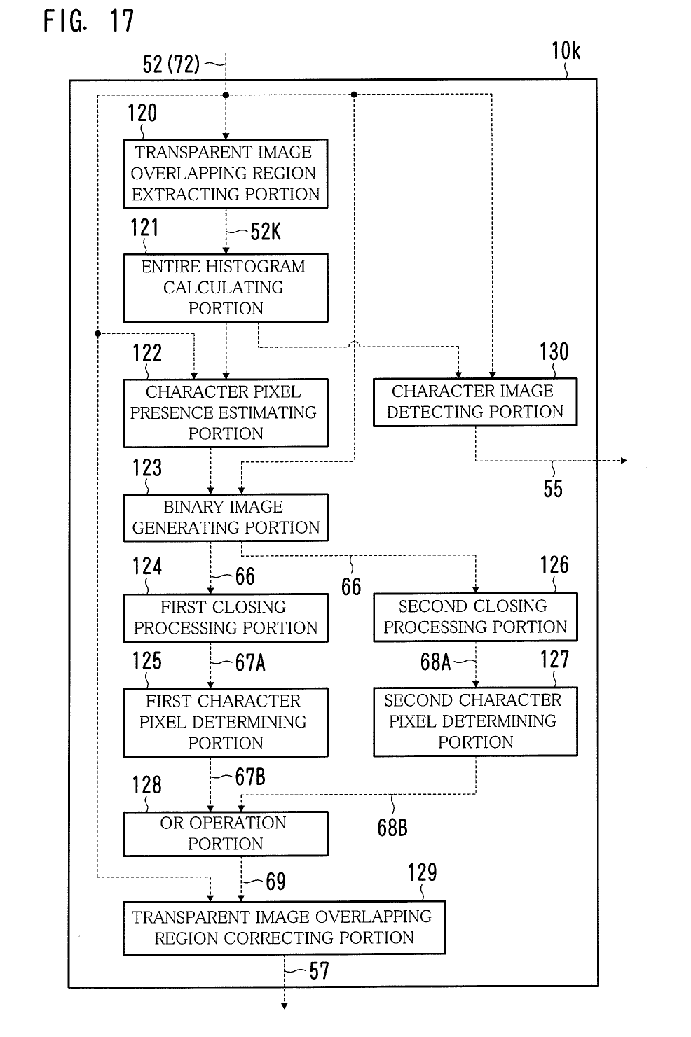

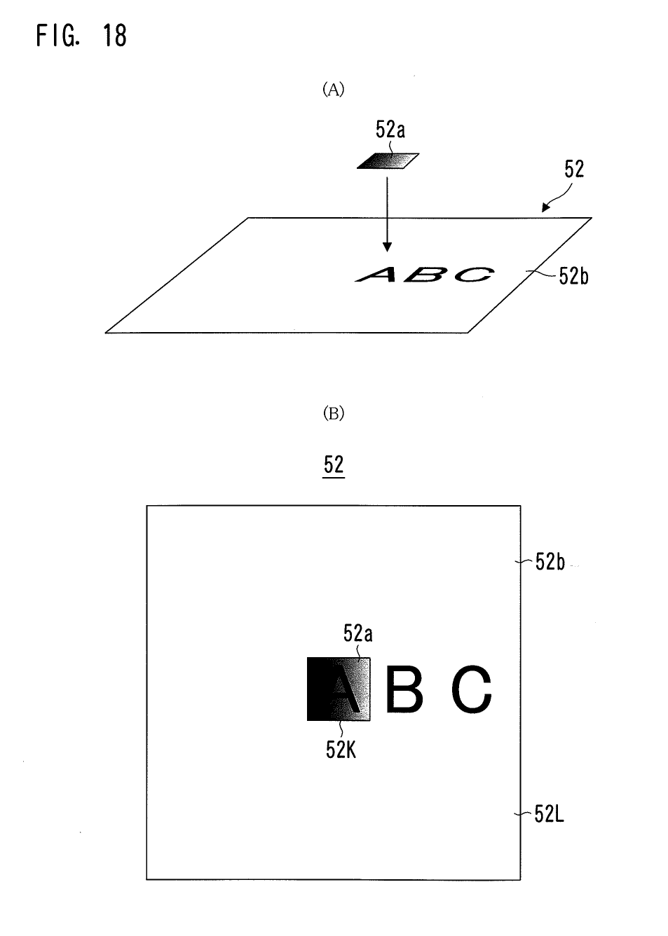

FIG. 3 is a diagram showing an example of a configuration of the image processing circuit 10j. FIGS. 4A and 4B show diagrams illustrating an example of how a transparent image 40a and a non-transparent image 40c are overlaid on a background image 40b. FIGS. 5A to 5C show diagrams illustrating examples of characteristics of transparent images. FIG. 6 is a diagram illustrating an example of how a transparent image 41a is overlaid on a background image 41b. FIGS. 7A and 7B show diagrams showing an example of a positional relationship between an original image 50, a transparent image 50a, a background image 50b, and so on. FIGS. 8A and 8B show diagrams showing an example of a transparent image overlapping region 50K and blocks 59. FIG. 9 shows a histogram showing an example of the number (distribution) of pixels for each level of hue. FIG. 10 is a diagram showing an example of a replaced image 60. FIG. 11 is a diagram showing an example of blocks 61. FIG. 12A to 12C show histograms showing an example of the number (distribution) of pixels for each level of hue. FIG. 13 is a diagram showing an example of a configuration of a character pixel determining portion 107. FIG. 14 shows diagrams illustrating an example of processing performed by a first pixel replacement portion 303, a first closing processing portion 304, and a first character pixel determining portion 305. FIG. 15 shows diagrams illustrating an example of processing performed by a second pixel replacement portion 306, a second closing processing portion 307, and a second character pixel determining portion 308. FIG. 16 is a diagram illustrating an example of processing performed by an OR operation portion 309.

As shown in FIG. 3, the image processing circuit 10j is configured by a transparent image overlapping region extracting portion 101, a first block dividing portion 102, a first histogram calculating portion 103, a non-peak-pixel replacement portion 104, a second block dividing portion 105, a second histogram calculating portion 106, a character pixel determining portion 107, a transparent image overlapping region correcting portion 108, and the like. The image processing circuit 10j performs image processing on an image to be printed. Specifically, the image processing is information processing for editing image data 70 representing an image to be printed.

In the present embodiment, the image data 70 is image data representing an image in which a transparent image is overlaid on another image.

Generally, “transparent image” refers to an image through which an image of an object that is behind the image can be seen. In other words, it can be said that the transparent image represents a translucent object such as glass or cellophane. An example of the transparent image is a transparent GIF (Graphics Interchange Format) image.

For example, as shown in FIG. 4A, a transparent image 40a is overlaid on the left half of a background image 40b, and a non-transparent image 40c is overlaid on the right half of the background image 40b. As shown in FIG. 4B, the portion of the background image 40b that is overlapped by the transparent image 40a can be seen through the transparent image 40a. However, the portion of the background image 40b that is overlapped by the non-transparent image 40c cannot be seen through the non-transparent image 40c.

The higher the transparency of a transparent image is, the more visible another image (or in other words, background image) that is overlapped by the transparent image is.

Also, generally, when a transparent image is displayed by the personal computer 4A or the like, all pixels have a uniform density as shown in FIG. 5A, but when the transparent image is printed, as shown in FIG. 5B or 5C, the pixels are converted to pixels having a uniform density and pixels having a non-uniform density.

In FIGS. 5B and 5C, hatched pixels are pixels having a uniform density, and unhatched pixels are pixels having a non-uniform density. This applies to FIGS. 6, 10, 11, (A) to (D) of FIG. 14, and (A) to (D) of FIG. 15. Hereinafter, the pixels having a uniform density will be referred to as “density-present pixels”, and the pixels having a non-uniform density will be referred to as “density-absent pixels”. Also, “density” refers to the gradation of colors (for example, red, green, blue and so on) in the case where the transparent image is a color image, or the grayscale in the case where the transparent image is a monochrome image.

The density-present pixels are printed at a predetermined density. The density-absent pixels are not printed if there is not another image behind these pixels, but if there is another image, pixels in the other image that are located in the corresponding positions of the density-absent pixels are printed.

Accordingly, as show in FIG. 6, for example, in the case where a part of a transparent image 41a is overlaid on a part of a background image 41b, pixels of the background image 41b disposed at the corresponding positions of density-absent pixels of the transparent image 41a are printed, whereby the transparent image 41a and the background image 41b are printed such that the background image 41b appears to be visible through the transparent image 41a.

Also, the higher the level of transparency of a transparent image, the lower the frequency of appearance of density-present pixels becomes. Accordingly, the transparent image shown in FIG. 5B has a higher level of transparency than the transparent image shown in FIG. 5C.

In FIG. 5B, density-absent pixels are present on the upper, lower, left and right sides of each density-present pixel. On the other hand, in FIG. 5C, density-present pixels are present on the upper, lower, left and right sides of each density-absent pixel.

Hereinafter, a pixel surrounded by pixels of another type will be referred to as an “isolated point”. Accordingly, in FIG. 5B, density-present pixels are isolated point pixels, and in FIG. 5C, density-absent pixels are isolated point pixels.

In the present embodiment, image processing performed by the image processing circuit 10j will be described using, for example, image data representing an original image 50 as the image data 70.

As shown in FIG. 7A, the original image 50 is an image in which a transparent image 50a is overlaid on a background image 50b.

Here, the transparent image 50a is smaller than the background image 50b. Accordingly, as shown in FIG. 7B, the original image 50 includes a region in which the background image 50b and the transparent image 50a overlap each other and a region consisting only of the background image 50b. Hereinafter, the former will be referred to as the “transparent image overlapping region 50K” and the latter will be referred to as the “transparent image non-overlapping region 50L”.

A character “A” is shown in the portion of the background image 50b that is overlapped by the transparent image 50a. The color of the character can be a specific color such as blue. The color of the background of the character can be another specific color such as green, and the color gradually lightens from left to right of FIGS. 7A and 7B. In short, the color of the background of the character is represented by gradation of the specific color.

The user creates the original image 50 by using an application, such as rendering software, that has been installed on the personal computer 4A. Data for reproducing the original image 50 is generated as the image data 70.

The personal computer 4A transmits the image data 70 to the image forming apparatus 1 together with a print instruction.

In the image forming apparatus 1, upon receiving the print instruction and the image data 70, the respective portions of the image processing circuit 10j execute processing such as follows.

The transparent image overlapping region extracting portion 101 distinguishes and extracts the transparent image overlapping region 50K from the original image 50.

Specifically, the transparent image overlapping region extracting portion 101 determines and detects the transparent image overlapping region 50K as follows based on the above-described characteristics of transparent images, for example.

The transparent image overlapping region extracting portion 101 detects isolated points from among the original image 50 in the following manner. Attention is focused on one pixel. This pixel will be hereinafter referred to as a “pixel of interest”. The density (gradation) of the pixel of interest is compared with the density of each of pixels (hereinafter referred to as “neighboring pixels”) present on the upper, lower, left and right sides of the pixel of interest.

If a requirement that the difference between the density of the pixel of interest and the density of one of the neighboring pixels is a predetermined value β or greater is satisfied for each of the neighboring pixels, the transparent image overlapping region extracting portion 101 detects the pixel of interest as an isolated point.

In the case where the original image 50 is a color image, the transparent image overlapping region extracting portion 101 performs the above comparison for each color. If any one of the colors satisfies the requirement, the pixel of interest is detected as an isolated point. Hereinafter, this applies to determining whether or not the requirement is satisfied in the case where the original image 50 is a color image.

As shown in FIGS. 5B and 5C, isolated points appear in a transparent image at a fixed periodicity (regularity). Thus, the transparent image overlapping region extracting portion 101 extracts isolated points that appear periodically from among the detected isolated points.

Then, the transparent image overlapping region extracting portion 101 performs closing processing on an image indicating the distribution of the extracted isolated points (hereinafter referred to as a “distribution image”). Specifically, processing for expanding (dilating) or scaling down (eroding) the dot located at the position of each isolated point is performed. The position and shape of the distribution image that has undergone closing processing substantially correspond to the position and shape of the transparent image overlapping region 50K.

The transparent image overlapping region extracting portion 101 identifies the position and shape of the transparent image overlapping region 50K in the manner described above, and extracts the transparent image overlapping region 50K from the original image 50.

In the case where the transparent image has a transparency level of around 50%, density-present pixels are detected as isolated points, and the pixels of the background image that are at the positions of density-absent pixels are also detected as isolated points. In other words, most of the pixels in the region are detected as isolated points. The density of each density-present pixel is uniform, but the density of the pixels of the background image that are in the positions of density-absent pixels is not uniform. Accordingly, in the case where most of the pixels in the region have been detected as isolated points, the transparent image overlapping region extracting portion 101 selects only isolated points having a uniform density, and performs closing using an image indicating the distribution of the selected isolated points as a distribution image.

The first block dividing portion 102 divides the transparent image overlapping region 50K extracted by the transparent image overlapping region extracting portion 101 into a predetermined number of blocks 59. In the present embodiment, the transparent image overlapping region 50K shown in FIG. 8A is divided into 2×2 blocks 59A to 59D as shown in FIG. 8B. The blocks 59A to 59D are assumed to have the same size.

In FIGS. 8A and 8B, hatched pixels are density-present pixels of the transparent image 50a. Both black pixels and gray pixels are pixels of the background image 50b that are in the positions of density-absent pixels of the transparent image 50a. The black pixels are pixels constituting a character “A” and the gray pixels are pixels constituting the background of the character.

The first histogram calculating portion 103 calculates a frequency distribution for each of the blocks 59A to 59D, the frequency distribution using the number of pixels for each level of density as the frequency. The calculated frequency distribution of each block can be represented as a histogram as shown in FIGS. 9A to 9C.

In the histogram of each block 59, a plurality of bin-widths can be observed each of which has one or more bins. In two of the bin-widths, a peak can be observed which has a uniform frequency or more and has a uniform sharpness or greater. One of the two peaks corresponds to the number (distribution) of pixels having the same level of density as the density-present pixels of the transparent image 50a. The other corresponds to the number (distribution) of pixels having the same level of density as the character in the background image 50b. Note that “sharpness” of a peak represents the magnitude of the absolute value of a rate of change in height between the peak and bin(s) adjacent to the peak.

The non-peak-pixel replacement portion 104 replaces pixels of the block 59A having a density different from the densities corresponding to the two peaks in the histogram of the block 59A with white pixels. Likewise, for each of the blocks 59B to 59D, the non-peak-pixel replacement portion 104 replaces pixels of the block having a density different from the densities corresponding to the two peaks in the histogram of the block with white pixels. Note that the non-peak-pixel replacement portion 104 may replace such pixels with pixels having colors other than white as long as such colors are not used in the transparent image overlapping region 50K.

Through the processing by the non-peak-pixel replacement portion 104, the replaced image 60 as that shown in FIG. 10 is obtained from the transparent image overlapping region 50K.

The second block dividing portion 105 divides the replaced image 60 obtained by the non-peak-pixel replacement portion 104 into a predetermined number of blocks 61. In the present embodiment, the replaced image 60 shown in FIG. 10 is divided into 4×4 blocks 61A to 61P as shown in FIG. 11. The blocks 61A to 61P are assumed to have the same size.

The second histogram calculating portion 106 calculates a frequency distribution for each of the blocks 61A to 61P, the frequency distribution using the number of pixels for each level of hue as the frequency. The calculated frequency distribution of each block can be represented as a histogram as shown in FIGS. 12A to 12C.

The histograms shown in FIGS. 12A, 12B, and 12C are histograms that represent the frequency distributions of block 61A, block 61B, and block 61C, respectively.

In the histograms, two or three peaks can be observed. Each peak corresponds to any one of the number (distribution) of pixels having the same level of hue as the density-present pixels of the transparent image 50a, the number (distribution) of pixels having the same level of hue as the character in the background image 50b, and the number (distribution) of pixels obtained through the replacement processing by the non-peak-pixel replacement portion 104 (white pixels in this embodiment).

As shown in FIG. 13, the character pixel determining portion 107 is configured by twenty-four comparison operation portions, a pixel type hue determining portion 302, a first pixel replacement portion 303, a first closing processing portion 304, a first character pixel determining portion 305, a second pixel replacement portion 306, a second closing processing portion 307, a second character pixel determining portion 308, an OR operation portion 309 and the like. With this configuration, the character pixel determining portion 107 distinguishes the pixels constituting the character from the pixels of the transparent image overlapping region 50K based on the frequency distributions of the blocks 61 calculated by the second histogram calculating portion 106 in the manner as described below. Hereinafter, the twenty-four comparison operation portions will also be referred to as the “first comparison operation portion 201”, the “second comparison operation portion 202” . . . , and the “twenty-fourth comparison operation portion 224” where it is necessary to make a distinction.

For the replaced image 60, there are twenty-four possible combinations of two vertically and horizontally adjacent blocks 61. In the character pixel determining portion 107, one comparison operation portion is provided for each combination. The comparison operation portion compares the frequency distributions of blocks 61 calculated by the second histogram calculating portion 106.

For example, the first comparison operation portion 201 compares the frequency distribution of block 61A and the frequency distribution of block 61B. The second comparison operation portion 202 compares the frequency distribution of block 61B and the frequency distribution of block 61C. The third comparison operation portion 203 compares the frequency distribution of block 61C and the frequency distribution of block 61D.

Each comparison operation portion compares the frequency distributions of blocks 61 in the manner as follows. As described with reference to FIGS. 12A to 12C, in the frequency distributions of the blocks 61, there are two or three peaks. The comparison operation portion compares the peaks that are on the same level of hue of two blocks 61.

For example, the first comparison operation portion 201 makes a comparison between the frequency of the first hue level Hu1 of the block 61A and the frequency of the first hue level Hu1 of the block 61B, between the frequency of the second hue level Hu2 of the block 61A and the frequency of the second hue level Hu2 of the block 61B, and between the frequency of the third hue level Hu3 of the block 61A and the frequency of the third hue level Hu3 of the block 61B.

Similarly, the second comparison operation portion 202 makes a comparison between the frequency of the first hue level Hu1 of the block 61B and the frequency of the first hue level Hu1 of the block 61C, between the frequency of the second hue level Hu2 of the block 61B and the frequency of the second hue level Hu2 of the block 61C, and between the frequency of the third hue level Hu3 of the block 61B and the frequency of the third hue level Hu3 of the block 61C.

Then, each comparison operation portion notifies the pixel type hue determining portion 302 of a hue level having a difference between two frequencies of less than a predetermined value a as a uniform hue level and a hue level having a difference between two frequencies of greater than or equal to the predetermined value a as a non-uniform hue level.

For example, the frequency distribution of the block 61A is as shown in the histogram of FIG. 12A, and the frequency distribution of the block 61B is as shown in the histogram of FIG. 12B. Comparing these two indicates that the block 61A and the block 61B have the same frequency of pixels at the hue level Hu3, but have different frequencies of pixels at the hue level Hu1 and the hue level Hu2.

Accordingly, the first comparison operation portion 201 notifies the pixel type hue determining portion 302 of the hue level Hu3 as a uniform hue level. Also, the first comparison operation portion 201 notifies the pixel type hue determining portion 302 of the hue level Hu1 and the hue level Hu2 as a uniform hue level or a non-uniform hue level depending on the predetermined value α. For example, if the predetermined value α is “1”, which can be satisfied when there is even a slight difference between two frequencies, the hue level Hu1 and the hue level Hu2 will be determined as a non-uniform hue level. Thus, the hue level Hu1 and the hue level Hu2 are notified as a non-uniform hue level.

The pixel type hue determining portion 302 obtains, from the twenty-four comparison operation portions, approximately twenty-four uniform hue levels and approximately forty eight non-uniform hue levels in total.

The pixel type hue determining portion 302 classifies the approximately twenty-four uniform hue levels, which have been notified, according to the value. In this example, the uniform hue levels are classified into any one of the first hue level Hu1, the second hue level Hu2 and the third hue level Hu3. Then, the one into which the greatest number of uniform hue levels have been classified is determined as the hue of the density-present pixels of the transparent image 50a. Consequently, in this example, the number of uniform hue levels that have been classified into the third hue level Hu3 is the greatest, and therefore the third hue level Hu3 is determined as the hue of the density-present pixels of the transparent image 50a. The distribution of hue of the density-present pixels of the transparent image 50a is substantially uniform among the blocks 61. Hereinafter, the hue level (uniform hue level) that has been determined as the hue level of the density-present pixels of the transparent image 50a will be referred to as the “density-present pixel hue level Hn”.

Furthermore, the pixel type hue determining portion 302 also classifies the approximately forty eight non-uniform hue levels, which have been notified, according to the value. In this example, the non-uniform hue levels are classified into any one of the first hue level Hu1, the second hue level Hu2 and the third hue level Hu3. Then, the classified non-uniform hue levels that are not the hue of the density-present pixels of the transparent image 50a are determined as the hue level of the pixels of the character of the background image 50b or as the hue level of the pixels that are obtained through the replacement processing by the non-peak-pixel replacement portion 104. In this example, the third hue level Hu3 has been determined as the hue of the density-present pixels of the transparent image 50a, and therefore the first hue level Hu1 and the second hue level Hu2 are determined as either the hue level of the pixels of the character of the background image 50b or as the hue level of the pixels that are obtained through the replacement processing by the non-peak-pixel replacement portion 104. Hereinafter, the two hue levels (non-uniform hue levels) thus determined will be referred to as the “first background image hue level Hg1” and the “second background image hue level Hg2”. The following description provides an example in which the first hue level Hu1 is the first background image hue level Hg1, and the second hue level Hu2 is the second background image hue level Hg2.

Then, the pixel type hue determining portion 302 notifies the first pixel replacement portion 303 and the second pixel replacement portion 306 of the density-present pixel hue level Hn, the first background image hue level Hg1 and the second background image hue level Hg2.

The first pixel replacement portion 303, the first closing processing portion 304 and the first character pixel determining portion 305 perform processing based on the image data 70, the density-present pixel hue level Hn, the first background image hue level Hg1 and the second background image hue level Hg2. A procedure of the processing will be described with reference to FIG. 14.

The first pixel replacement portion 303 searches the replaced image 60 for pixels that have the density-present pixel hue level Hn. As a result, the hatched pixels in (A) of FIG. 14 are obtained. Then, the first pixel replacement portion 303 replaces the pixels having the density-present pixel hue level Hn with the pixels (white pixels) having the first background image hue level Hg1 as shown in (B) of FIG. 14. Hereinafter, the image of the replaced image 60 that has undergone replacement processing performed by the first pixel replacement portion 303 will be referred to as a “replacement processed image 62A”.

The first closing processing portion 304 performs closing processing on the replacement processed image 62A by dilating and eroding the pixels (black pixels) having the second background image hue level Hg2. As a result, a resultant image as shown in (C) of FIG. 14 is obtained. Hereinafter, the replacement processed image 62A that has undergone closing processing performed by the first closing processing portion 304 will be referred to as a “closing processed image 62B”.

The hue level of the pixels constituting the closing processed image 62B is one of the first background image hue level Hg1 and the second background image hue level Hg2.

The first character pixel determining portion 305 determines either of the pixels of the first background image hue level Hg1 and the pixels of the second background image hue level Hg2 that is smaller in number as pixels constituting the character. Then, the first character pixel determining portion 305 binarizes the closing processed image 62B such that the pixels determined as pixels constituting the character have a value of “1” and the other pixels have a value of “0”. As a result, a resultant image as shown in (D) of FIG. 14 is obtained. In (D) of FIG. 14, the pixels with a black dot have a value of “1” and the pixels without a black dot have a value of “0”. This applies to (D) of FIG. 15 and FIG. 16 described later. Hereinafter, the closing processed image 62B that has been binarized by the first character pixel determining portion 305 will be referred to as a “first binary image 62C”.

The second pixel replacement portion 306, the second closing processing portion 307 and the second character pixel determining portion 308 also perform processing based on the image data 70, the density-present pixel hue level Hn, the first background image hue level Hg1 and the second background image hue level Hg2, as with the first pixel replacement portion 303, the first closing processing portion 304 and the first character pixel determining portion 305. However, the use of the first background image hue level Hg1 and the second background image hue level Hg2 is different.

Processing performed by the second pixel replacement portion 306, the second closing processing portion 307 and the second character pixel determining portion 308 will be described with reference to FIG. 15.

The second pixel replacement portion 306 searches the replaced image 60 for pixels that have the density-present pixel hue level Hn, and replaces the obtained pixels with pixels (black pixels) that have the second background image hue level Hg2 as shown in (B) of FIG. 15. Hereinafter, the replaced image 60 that has undergone replacement processing performed by the second pixel replacement portion 306 will be referred to as a “replacement processed image 63A”.

The second closing processing portion 307 performs closing processing on the replacement processed image 63A by dilating and eroding the pixels (white pixels) having the first background image hue level Hg1. As a result, a resultant image as shown in (C) of FIG. 15 is obtained. Hereinafter, the replacement processed image 63A that has undergone closing processing performed by the second closing processing portion 307 will be referred to as a “closing processed image 63B”.

The hue level of the pixels constituting the closing processed image 63B is also one of the first background image hue level Hg1 and the second background image hue level Hg2, as with the hue level of the pixels constituting the closing processed image 62B.

The second character pixel determining portion 308 determines either of the pixels of the first background image hue level Hg1 and the pixels of the second background image hue level Hg2 that is smaller in number as pixels constituting the character. Then, the second character pixel determining portion 308 binarizes the closing processed image 63B such that the pixels determined as pixels constituting the character have “1” and the other pixels have “0”. As a result, a resultant image as shown in (D) of FIG. 15 is obtained. Hereinafter, the closing processed image 63B that has been binarized by the second character pixel determining portion 308 will be referred to as a “second binary image 63C”.

The OR operation portion 309 calculates the logical OR of a pixel in the first binary image 62C and the pixel at the corresponding position in the second binary image 63C as shown in FIG. 16. A binary image 64 indicates the logical OR of each position.

The pixels having a value of “1” in the binary image 64 correspond to the pixels constituting the character in the transparent image overlapping region 50K.

As described above, the pixels constituting the character in the transparent image overlapping region 50K are determined through the processing performed by the constituent elements of the character pixel determining portion 107.

Referring back to FIG. 3, the transparent image overlapping region correcting portion 108 corrects the transparent image overlapping region 50K in the original image 50 based on the result determined by the character pixel determining portion 107 and the like. For example, the transparent image overlapping region correcting portion 108 performs edge enhancement processing on a pixel group that has been determined as the pixels constituting the character and blur processing on the remaining portion. Hereinafter, the original image 50 that has been processed by the transparent image overlapping region correcting portion 108 will be referred to as a “corrected image 55”.

After that, the printing apparatus 10f prints the corrected image 55 on a sheet of paper. Alternatively, the network interface 10g transmits the image data of the corrected image 55 to the personal computer 4A or the like.

According to the first embodiment, a character can be detected from a gradation region on which the transparent image is overlapped with greater accuracy than conventional technology.

### Second Embodiment

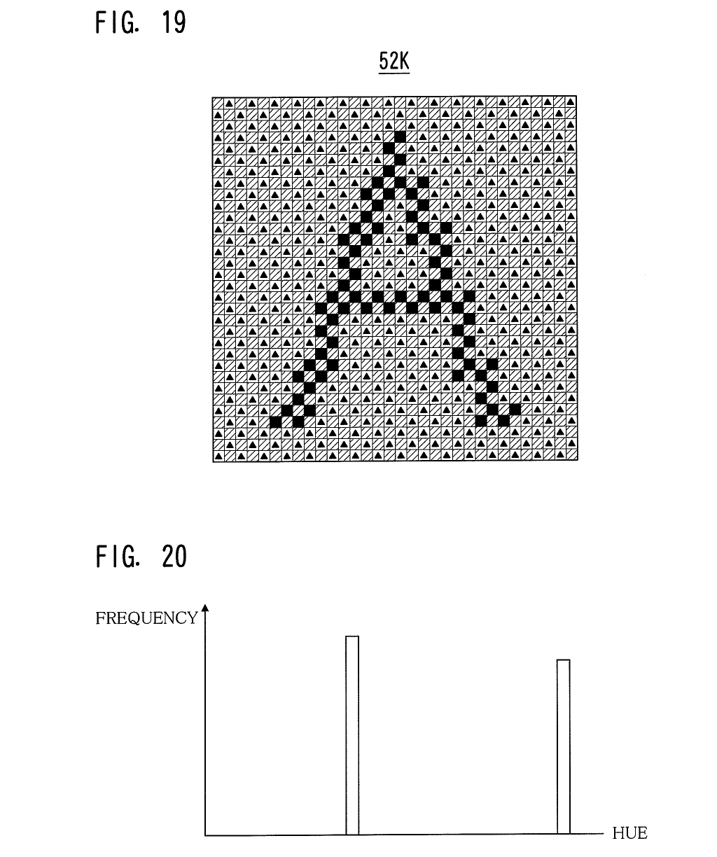

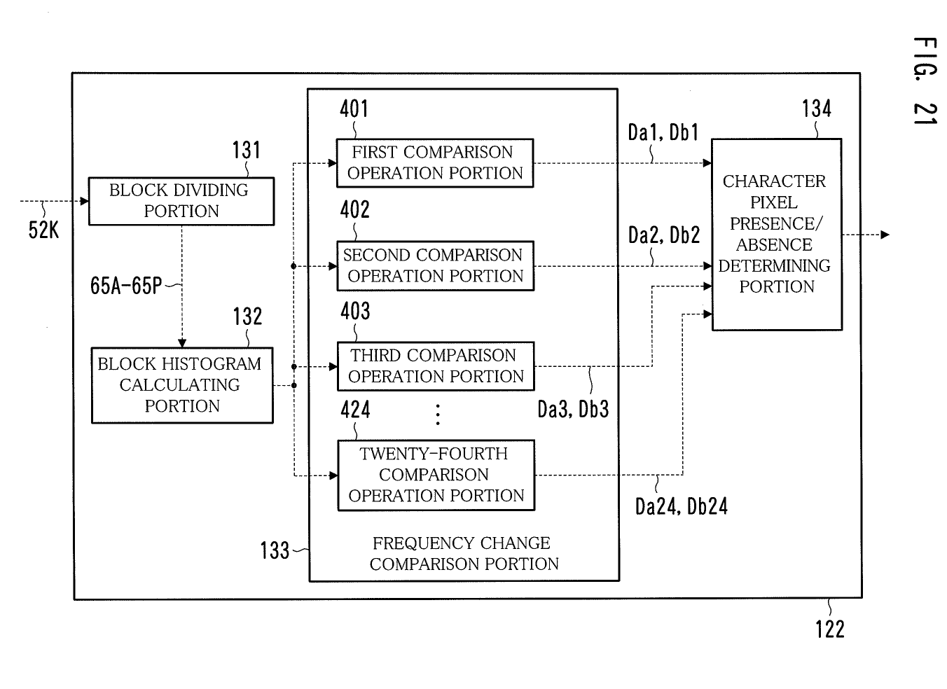

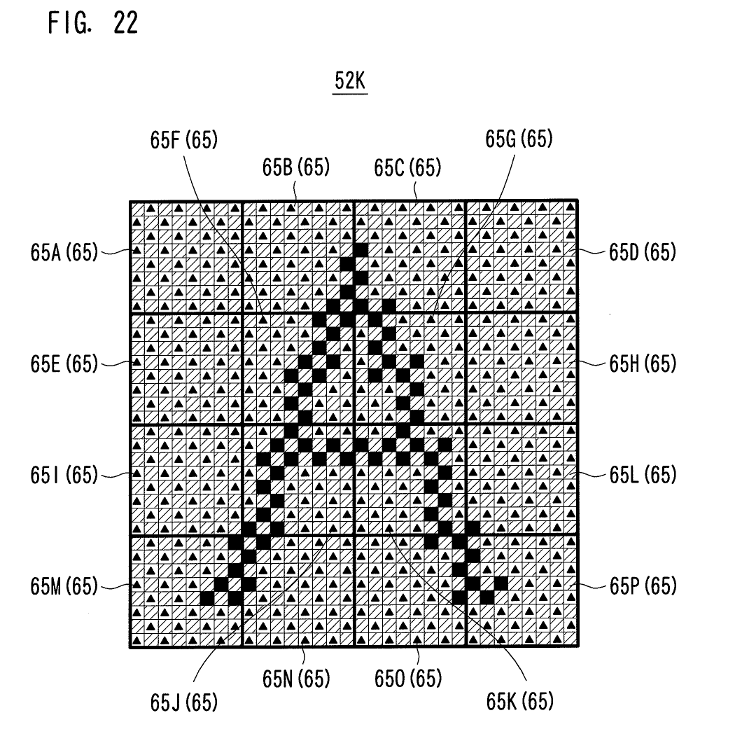

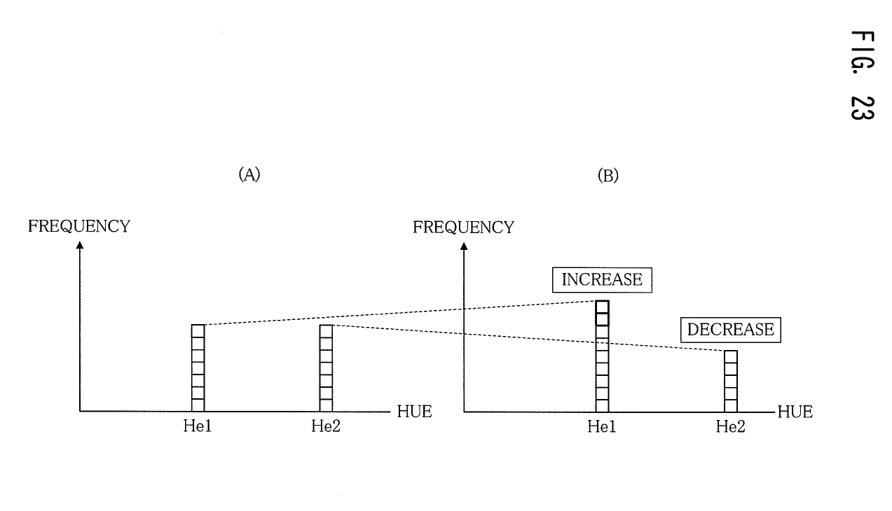

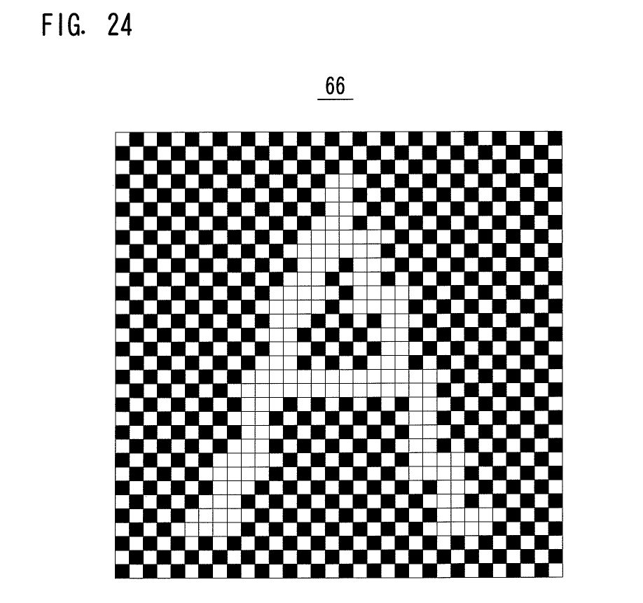

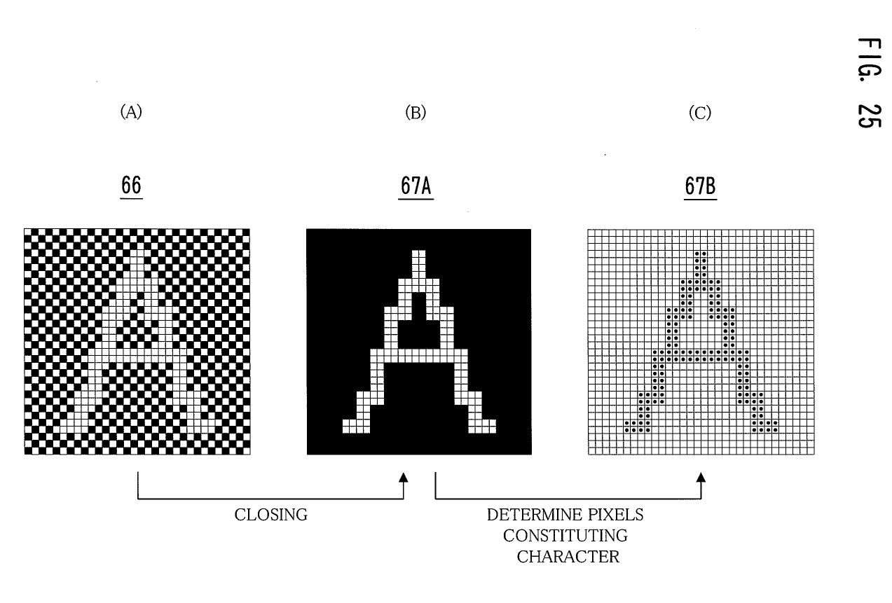

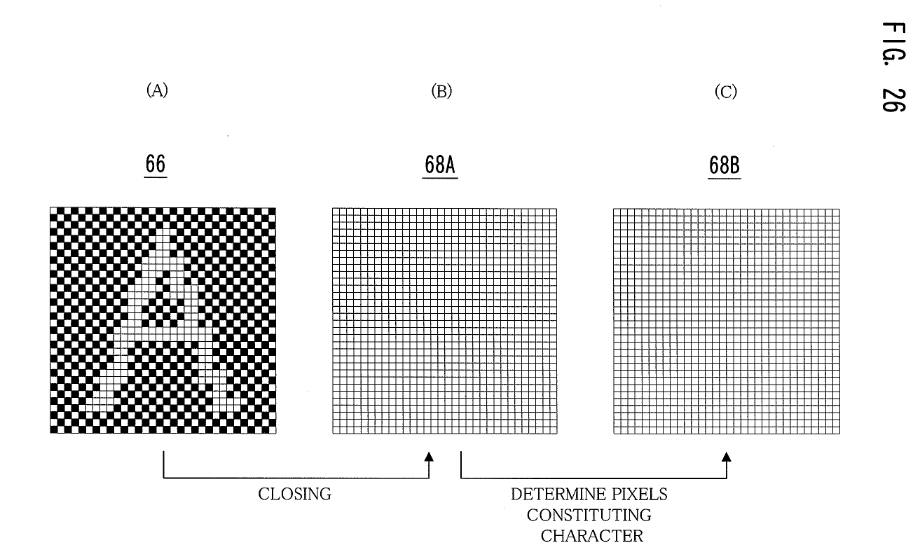

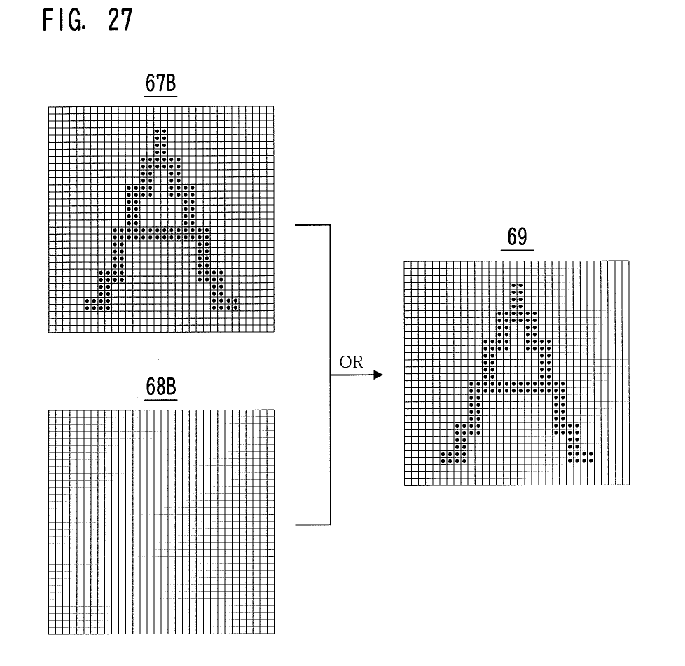

FIG. 17 is a diagram showing an example of a configuration of an image processing circuit 10k. FIGS. 18A and 18B are diagrams showing an example of a positional relationship between an original image 52, a transparent image 52a, a background image 52b, and so on. FIG. 19 is a diagram showing an example of a transparent image overlapping region 52K. FIG. 20 shows a histogram showing an example of the number (distribution) of pixels for each level of hue. FIG. 21 is a diagram showing an example of a configuration of a character pixel presence estimating portion 122. FIG. 22 is a diagram showing an example of blocks 65. FIG. 23 shows histograms showing an example of the number (distribution) of pixels for each level of hue. FIG. 24 shows an example of a binary image 66. FIG. 25 shows an example of processing performed by a first closing processing portion 124 and a first character pixel determining portion 125. FIG. 26 shows an example of processing performed by a second closing processing portion 126 and a second character pixel determining portion 127. FIG. 27 is a diagram illustrating an example of processing performed by an OR operation portion 128.

In the first embodiment, the hue level of the density-present pixels of the transparent image 50a is different from the hue level of the character in the background image 50b as shown in FIGS. 7A to 7B, and so on.

In the second embodiment, the image forming apparatus 1 performs processing so that a character can be detected even when the hue level of the density-present pixels of the transparent image 50a is the same as the hue level of the character in the background image 50b.

The image forming apparatus 1 basically has the same hardware configuration as that of the image forming apparatus 1 shown in FIG. 3 according to the first embodiment. However, the image forming apparatus 1 according to the second embodiment is provided with an image processing circuit 10k instead of the image processing circuit 10j.

As shown in FIG. 17, the image processing circuit 10k is configured by a transparent image overlapping region extracting portion 120, an entire histogram calculating portion 121, a character pixel presence estimating portion 122, a binary image generating portion 123, a first closing processing portion 124, a first character pixel determining portion 125, a second closing processing portion 126, a second character pixel determining portion 127, an OR operation portion 128, a transparent image overlapping region correcting portion 129, and the like.

The processing details by the entire histogram calculating portion 121 through the transparent image overlapping region correcting portion 129 mentioned above are described in due order by taking an example of processing on an original image 52 in which a character “A” of the background image 52b is overlapped by the transparent image 52a (see FIGS. 18A to 19). Descriptions of processing common to those of the first embodiment shall be omitted. A region in which the background image 52b and the transparent image 52a overlap each other is referred to as the “transparent image overlapping region 52K”, and a region consisting only of the background image 52b is referred to as the “transparent image non-overlapping region 52L”.

Referring to FIG. 19, hatched pixels are density-present pixels of the transparent image 52a. The character “A” is shown in the portion of the background image 52b that is overlapped by the transparent image 52a. Black pixels are pixels constituting the character. Pixels indicated by a triangle mark are pixels constituting the background of the character of the background image 52b.

The color of the character can be a specific color such as green. The color of the background of the character can be another specific color such as red. In the second embodiment, the density of the background of the background image 52b is uniform, while, in the first embodiment, the background of the background image 50b is represented by gradation.

The color of the density-present pixels of the transparent image 52a gradually lightens from left to right of FIGS. 18A and 18B. In short, in the second embodiment, the transparent image 52a is represented by gradation, and, the density-present pixels have a uniform hue level and have a density falling within a uniform range. Further, the hue level of the transparent image 52a is identical to the hue level of the character of the background image 52b. In FIGS. 19 and 22, the gradation is omitted for easy viewing.

When the image data 72 for reproducing the original image 52 is received, the transparent image overlapping region extracting portion 120 distinguishes and extracts the transparent image overlapping region 52K from the original image 52, as with the transparent image overlapping region extracting portion 101 (see FIG. 3) of the first embodiment.

The entire histogram calculating portion 121 calculates a frequency distribution for each level of hue in the entirety of the transparent image overlapping region 52K. As a result, a histogram having two peaks is obtained as shown in FIG. 20.

When a histogram having three peaks is obtained, a character image detecting portion 130 performs the processing discussed in the first embodiment, in particular, the same processing as that by the first block dividing portion 102 through the transparent image overlapping region correcting portion 108 (see FIG. 3). Thereby, the character image detecting portion 130 detects a character in the transparent image overlapping region 52K.

When a histogram having two peaks is obtained, the character pixel presence estimating portion 122 through the transparent image overlapping region correcting portion 129 shown in FIG. 17 perform the following processing.

As shown in FIG. 21, the character pixel presence estimating portion 122 is configured by a block dividing portion 131, a block histogram calculating portion 132, a frequency change comparison portion 133, a character pixel presence/absence determining portion 134, and the like. The individual portions of the character pixel presence estimating portion 122 predict whether or not there are pixels constituting a character in the transparent image overlapping region 52K.

The block dividing portion 131 divides the transparent image overlapping region 52K extracted by the transparent image overlapping region extracting portion 120 into a predetermined number of blocks 65. In the present embodiment, the transparent image overlapping region 52K is divided into 4×4 blocks 65A to 65P as shown in FIG. 22. The blocks 65A to 65P are assumed to have the same size.

The block histogram calculating portion 132 calculates a frequency distribution for each of the blocks 65A to 65P, the frequency distribution using the number of pixels for each level of hue as the frequency. The calculated frequency distribution of each block can be represented as a histogram as shown in FIG. 23. The histograms shown in Fig. (A) and (B) of FIG. 23 are histograms that represent the frequency distributions of the block 65A and block 61B, respectively.

In these histograms, two peaks can be observed. One of the peaks corresponds to the number (distribution) of pixels having the same level of hue as that of the density-present pixels of the transparent image 52a and that of the character in the background image 52b. The other corresponds to the number (distribution) of pixels of the background in the background image 52b. Hereinafter, the hue level of the former peak is referred to as the “first hue level He1”, and the hue level of the latter peak is referred to as the “second hue level He2”.

In the meantime, for the transparent image overlapping region 52K, there are twenty-four possible combinations of two vertically and horizontally adjacent blocks 65, as with the replaced image 60 of the first embodiment.

In the frequency change comparison portion 133, one comparison operation portion is provided for each combination. The comparison operation portion compares the frequency distributions of blocks 65 calculated by the block histogram calculating portion 132. Hereinafter, the twenty-four comparison operation portions are sometimes referred to as the “first comparison operation portion 401”, the “second comparison operation portion 402” . . . , and the “twenty-fourth comparison operation portion 424” where it is necessary to make a distinction.

For example, the first comparison operation portion 401 compares the frequency distribution of block 65A and the frequency distribution of block 65B. The second comparison operation portion 402 compares the frequency distribution of block 65B and the frequency distribution of block 65C. The third comparison operation portion 403 compares the frequency distribution of block 65C and the frequency distribution of block 65D.

Each of the comparison operation portions compares, for two blocks 65 corresponding to each combination, the frequencies of peaks having the same hue level, and calculates the difference therebetween. In this way, twenty-four differences in first hue level He1 between two adjacent blocks 65 are calculated. Likewise, twenty-four differences in second hue level He2 between two adjacent blocks 65 are calculated.

It is assumed that the difference in frequency between horizontally adjacent blocks 65 is obtained by subtracting the frequency of the right block from the frequency of the left block. Further, it is assumed that the difference in frequency between vertically adjacent blocks 65 is obtained by subtracting the frequency of the lower block from the frequency of the higher block. Thus, the difference may be a positive value, a negative value, and zero.

Hereinafter, the difference in first hue level He1 calculated by the first comparison operation portion 401, the second comparison operation portion 402 . . . , and the twenty-fourth comparison operation portion 424 are referred to as the “first frequency difference Da1”, the “second frequency difference Da2” . . . , and the “twenty-fourth frequency difference Da24, respectively. Likewise, the difference in second hue level He2 calculated by the first comparison operation portion 401, the second comparison operation portion 402 . . . , and the twenty-fourth comparison operation portion 424 are referred to as the “first frequency difference Db1”, the “second frequency difference Db2” . . . , and the “twenty-fourth frequency difference Db24”, respectively.

The character pixel presence/absence determining portion 134 determines whether or not there are pixels constituting a character in each block 65 of the transparent image overlapping region 52K in the following manner based on the frequency differences calculated by the twenty-four comparison operation portions.

The character pixel presence/absence determining portion 134 determines whether or not each of the twenty-four sets of the first frequency difference Dai and the second frequency difference Dbi satisfies the following equations (1) to (3).

Dai=−Dbi (1)

Dai>0 (2)

Dbi>0 (3)

where i=1, 2, . . . , and 24.

The character pixel presence/absence determining portion 134, then, determines that two blocks corresponding to a set of the first frequency difference Dai and the second frequency difference Dbi satisfying all the equations (1) to (3) have pixels constituting a character.

For example, for the case of Da1=−Db1, the character pixel presence/absence determining portion 134 determines that the two blocks 65A and 65B have pixels constituting a character.

Through the processing by the character pixel presence/absence determining portion 134, it is determined that all the blocks 65 shown in FIG. 22 have pixels constituting a character.

Referring back to FIG. 17, the binary image generating portion 123 converts, the blocks 65, of the transparent image overlapping region 52K, which have been determined to have pixels constituting a character by the character pixel presence estimating portion 122 into a binary image 66 in which pixels having the first hue level He1 are distinguished from pixels having the second hue level He2. As described above, it is determined that all the blocks 65 in the transparent image overlapping region 52K shown in FIG. 22 have pixels constituting a character.

Accordingly, the binary image generating portion 123 performs processing on the entirety of the transparent image overlapping region 52K such that the pixels having the first hue level He1 are replaced with white pixels and the pixels having the second hue level He2 are replaced with black pixels. As a result, the binary image 66 is obtained as shown in FIG. 24.

The first closing processing portion 124 performs closing processing on the binary image 66 (see (A) of FIG. 25) by dilating and eroding the black pixels (pixels corresponding to the pixels having the second hue level He2 in the transparent image overlapping region 52K). As a result, a resultant image as shown in (B) of FIG. 25 is obtained. Hereinafter, the binary image 66 that has undergone closing processing performed by the first closing processing portion 124 is referred to as a “closing processed image 67A”.

The first character pixel determining portion 125 determines either of the white pixels and the black pixels that is smaller in number as pixels constituting the character. Then, the first character pixel determining portion 125 overwrites the closing processed image 67A such that the pixels determined as pixels constituting the character have a value of “1” and the other pixels have a value of “0”. As a result, a resultant image as shown in (C) of FIG. 25 is obtained.

In (C) of FIG. 25, the pixels with a black dot have a value of “1” and the pixels without a black dot have a value of “0”. This applies to (C) of FIG. 26 and FIG. 27 described later. Hereinafter, the image obtained by the first character pixel determining portion 125 will be referred to as a “first character region image 67B”.

The second closing processing portion 126 and the second character pixel determining portion 127 also perform the same processing as that by the first closing processing portion 124 and the first character pixel determining portion 125. However, the use of the first hue level He1 and the second hue level He2 is different.

The second closing processing portion 126 performs closing processing on the binary image 66 (see (A) of FIG. 26) by dilating and eroding the white pixels (pixels corresponding to the pixels having the first hue level He1 in the transparent image overlapping region 52K). As a result, a closing processed image 68A as shown in (B) of FIG. 26 is obtained.

The second character pixel determining portion 127 determines either of the white pixels and the black pixels that is smaller in number as pixels constituting the character, as with the first character pixel determining portion 125. Then, the second character pixel determining portion 127 overwrites the closing processed image 68A such that the pixels determined as pixels constituting the character have “1” and the other pixels have “0”. As a result, a second character region image as shown in (C) of FIG. 26 is obtained.

The OR operation portion 128 calculates the logical OR of a pixel in the first character region image 67B and the pixel at the corresponding position in the second character region image 68B as shown in FIG. 27. A binary image 69 indicates the logical OR of each position.

The pixels having a value of “1” in the binary image 69 correspond to the pixels constituting the character in the transparent image overlapping region 52K.

Through the foregoing processing, the pixels constituting the character in the transparent image overlapping region 52K are determined.

The transparent image overlapping region correcting portion 129 corrects the transparent image overlapping region 52K in the original image 52. For example, the transparent image overlapping region correcting portion 129 performs edge enhancement processing on a pixel group that has been determined as the pixels constituting the character and blur processing on the remaining portion. Hereinafter, the original image 52 that has been processed by the transparent image overlapping region correcting portion 129 is referred to as a “corrected image 57”.

After that, the printing apparatus 10f prints the corrected image 57 on a sheet of paper. Alternatively, the network interface 10g transmits the image data of the corrected image 57 to the personal computer 4A or the like.

According to the second embodiment, a character can be detected from a region overlapped by a transparent image having gradation with greater accuracy than conventional technology.

In the first embodiment, the transparent image overlapping region 50K is detected based on the regularity of the positions of isolated points serving as density-present pixels, but in the case where the image data 70 already contains data indicating the position of the transparent image 50a, the transparent image overlapping region 50K may be detected based on the data. Likewise, for the transparent image overlapping region 52K in the second embodiment, in the case where the image data 72 already contains data indicating the position of the transparent image 52a, the transparent image overlapping region 52K may be detected based on the data.

In the first and second embodiments, each region is divided into four blocks or sixteen blocks, but the number of blocks may be less than four or may be more than sixteen.

In the first and second embodiments, the frequency distributions of vertically and horizontally adjacent blocks are compared, but any other combinations may be compared. For example, the frequency distributions of diagonally adjacent blocks may be compared. Alternatively, the frequency distributions of only vertically adjacent blocks may be compared, or the frequency distributions of only horizontally adjacent blocks may be compared.

In the first and second embodiments, each region is divided into a plurality of blocks of equal size, but it may be divided into a plurality of blocks of different sizes. In this case, it is desirable to calculate, instead of the number of pixels, the percentage of pixels corresponding to the block in the entire block as the frequency of pixels at each hue level.

In the first embodiment, detection of the character from the transparent image overlapping region 50K is performed primarily by the image processing circuit 10j, but it may be performed by the CPU 10a executing a computer program. In this case, a computer program is prepared that includes a program module containing, as a main routine, the processing procedure performed by the transparent image overlapping region extracting portion 101 through the transparent image overlapping region correcting portion 108 shown in FIG. 3 and a program module containing, as a sub routine, the processing procedure performed by the individual portions of the character pixel determining portion 107 shown in FIG. 13. The computer program is stored in the ROM 10c or the large-capacity storage apparatus 10d and executed by the CPU 10a.

Likewise, in the second embodiment, detection of the character from the transparent image overlapping region 52K is performed primarily by the image processing circuit 10k, but it may be performed by the CPU 10a executing a computer program. To be specific, a computer program is prepared that includes a program module containing, as a main routine, the processing procedure performed by the entire histogram calculating portion 121 through the transparent image overlapping region correcting portion 129 shown in FIG. 17 and a program module containing, as a sub routine, the processing procedure performed by the individual portions of the character pixel presence estimating portion 122 shown in FIG. 21. The computer program is then executed by the CPU 10a.

According to an embodiment of the present invention, a character can be detected from a region overlapped by a transparent image having gradation with greater accuracy than conventional technology.

It is to be understood that the configurations of the image forming apparatus 1 and the constituent elements thereof, the content and order of the processing, the configuration of data, and the like can be appropriately modified without departing from the spirit of the present invention.

It is to be understood that the present invention is not limited to example embodiments illustrated in the drawings, since the invention is capable of other embodiments and of being practiced or carried out in various ways. Also it is to be understood that the phraseology or terminology employed herein is for the purpose of description and not of limitation.

1. A character detection apparatus that detects, from an image including a first image representing a character and a second image representing a translucent object, the character, the character detection apparatus comprising:
a hue distribution calculating portion that, for each of blocks obtained by dividing an overlapping region in which the first image is overlapped by the second image, calculates a frequency of appearance of pixels for each of hues; and
a detection portion that detects the character from the overlapping region based on the frequency for each of the hues.

2. The character detection apparatus according to claim 1, comprising:
a density distribution calculating portion that calculates a density frequency in the overlapping region, the density frequency being a frequency of appearance of pixels for each of densities;
a replacement portion that, in a case where a first density frequency having uniform sharpness and a second density frequency having uniform sharpness are calculated as the density frequency, replaces a pixel, in the overlapping region, having a density different from a density corresponding to the first density frequency and from a density corresponding to the second density frequency with a first pixel having a first hue of the hues;
a generating portion that, in a case where a first frequency, a second frequency and a third frequency of the frequencies are peaks, the first frequency being a frequency for the first hue, the second frequency being a frequency for a second hue of the hues and the third frequency being a frequency for a third hue of the hues, and where a difference between the third frequencies of any two of the blocks is smaller than a difference between the first frequencies of said two of the blocks and a difference between the second frequencies of said two the blocks, generates a first replacement image by replacing a third pixel that has the third hue and is a part of the replaced pixels in the overlapping region with the first pixel, and generates a second replacement image by replacing the third pixel of the replaced pixels in the overlapping region with a second pixel having the second hue;
a first closing processing portion that performs closing on the first pixel in the first replacement image; and
a second closing processing portion that performs closing on the second pixel in the second replacement image,
wherein the detection portion detects, as the character, a set of pixels that are located at positions corresponding to positions of the first pixel in the closing processed first replacement image or at positions corresponding to positions of the second pixel in the closing processed second replacement image, from the overlapping region.

3. The character detection apparatus according to claim 1, comprising:
a generating portion that, in a case where a first frequency and a second frequency of the frequencies are peaks, the first frequency being a frequency for a first hue of the hues, and the second frequency being a frequency for a second hue of the hues, generates a first replacement image by replacing a second pixel having the second hue of pixels in the overlapping region with a first pixel having the first hue, and generates a second replacement image by replacing the first pixel of the pixels in the overlapping region with the second pixel;
a first closing processing portion that performs closing on the first pixel in the first replacement image; and
a second closing processing portion that performs closing on the second pixel in the second replacement image,
wherein the detection portion detects, as the character, a set of pixels that are located at positions corresponding to positions of the first pixel in the closing processed first replacement image or at positions corresponding to positions of the second pixel in the closing processed second replacement image, from the overlapping region.

4. A character detection method for detecting, from an image including a first image representing a character and a second image representing a translucent object, the character, the character detection method comprising:
a first step for calculating, for each of blocks obtained by dividing an overlapping region in which the first image is overlapped by the second image, a frequency of appearance of pixels for each of hues; and
a second step for detecting the character from the overlapping region based on the frequency for each of the hues.

5. The character detection method according to claim 4, comprising:
a third step for calculating a density frequency in the overlapping region, the density frequency being a frequency of appearance of pixels for each of densities;
a fourth step, in a case where a first density frequency having uniform sharpness and a second density frequency having uniform sharpness are calculated as the density frequency, for replacing a pixel, in the overlapping region, having a density different from a density corresponding to the first density frequency and from a density corresponding to the second density frequency with a first pixel having a first hue of the hues;
a fifth step, in a case where a first frequency, a second frequency and a third frequency of the frequencies are peaks, the first frequency being a frequency for the first hue, the second frequency being a frequency for a second hue of the hues and the third frequency being a frequency for a third hue of the hues, and where a difference between the third frequencies of any two of the blocks is smaller than a difference between the first frequencies of said two of the blocks and a difference between the second frequencies of said two the blocks, for generating a first replacement image by replacing a third pixel that has the third hue and is a part of the replaced pixels in the overlapping region with the first pixel, and for generating a second replacement image by replacing the third pixel of the replaced pixels in the overlapping region with a second pixel having the second hue;
a sixth step for performing closing on the first pixel in the first replacement image; and
a seventh step for performing closing on the second pixel in the second replacement image,
wherein the second step includes detecting, as the character, a set of pixels that are located at positions corresponding to positions of the first pixel in the closing processed first replacement image or at positions corresponding to positions of the second pixel in the closing processed second replacement image, from the overlapping region.

6. The character detection method according to claim 4, comprising:
a third step, in a case where a first frequency and a second frequency of the frequencies are peaks, the first frequency being a frequency for a first hue of the hues, and the second frequency being a frequency for a second hue of the hues, for generating a first replacement image by replacing a second pixel having the second hue of pixels in the overlapping region with a first pixel having the first hue, and for generating a second replacement image by replacing the first pixel of the pixels in the overlapping region with the second pixel;
a fourth step for performing closing on the first pixel in the first replacement image; and
a fifth step for performing closing on the second pixel in the second replacement image,
wherein the second step includes detecting, as the character, a set of pixels that are located at positions corresponding to positions of the first pixel in the closing processed first replacement image or at positions corresponding to positions of the second pixel in the closing processed second replacement image, from the overlapping region.

7. A non-transitory computer-readable storage medium storing thereon a computer program used in a computer for detecting, from an image including a first image representing a character and a second image representing a translucent object, the character, the computer program causing the computer to implement processes comprising:
first processing for calculating, for each of blocks obtained by dividing an overlapping region in which the first image is overlapped by the second image, a frequency of appearance of pixels for each of hues; and
second processing for detecting the character from the overlapping region based on the frequency for each of the hues.

8. The non-transitory computer-readable storage medium according to claim 7, the computer program causing the computer to implement processes comprising:
third processing for calculating a density frequency in the overlapping region, the density frequency being a frequency of appearance of pixels for each of densities;
fourth processing, in a case where a first density frequency having uniform sharpness and a second density frequency having uniform sharpness are calculated as the density frequency, for replacing a pixel, in the overlapping region, having a density different from a density corresponding to the first density frequency and from a density corresponding to the second density frequency with a first pixel having a first hue of the hues;
fifth processing, in a case where a first frequency, a second frequency and a third frequency of the frequencies are peaks, the first frequency being a frequency for the first hue, the second frequency being a frequency for a second hue of the hues and the third frequency being a frequency for a third hue of the hues, and where a difference between the third frequencies of any two of the blocks is smaller than a difference between the first frequencies of said two of the blocks and a difference between the second frequencies of said two the blocks, for generating a first replacement image by replacing a third pixel that has the third hue and is a part of the replaced pixels in the overlapping region with the first pixel, and for generating a second replacement image by replacing the third pixel of the replaced pixels in the overlapping region with a second pixel having the second hue;
sixth processing for performing closing on the first pixel in the first replacement image; and
seventh processing for performing closing on the second pixel in the second replacement image,
wherein the second processing includes detecting, as the character, a set of pixels that are located at positions corresponding to positions of the first pixel in the closing processed first replacement image or at positions corresponding to positions of the second pixel in the closing processed second replacement image, from the overlapping region.

9. The non-transitory computer-readable storage medium according to claim 7, the computer program causing the computer to implement processes comprising:
third processing, in a case where a first frequency and a second frequency of the frequencies are peaks, the first frequency being a frequency for a first hue of the hues, and the second frequency being a frequency for a second hue of the hues, for generating a first replacement image by replacing a second pixel having the second hue of pixels in the overlapping region with a first pixel having the first hue, and for generating a second replacement image by replacing the first pixel of the pixels in the overlapping region with the second pixel;
fourth processing for performing closing on the first pixel in the first replacement image; and
fifth processing for performing closing on the second pixel in the second replacement image,
wherein the second processing includes detecting, as the character, a set of pixels that are located at positions corresponding to positions of the first pixel in the closing processed first replacement image or at positions corresponding to positions of the second pixel in the closing processed second replacement image, from the overlapping region.
